(19) United States
(12) Patent Application Publication
(10) Pub. No.: US 2014/0368157 A1
(43) Pub. Date: Dec. 18, 2014

(54) ENERGY STORAGE SYSTEM FOR FOOT-POWERED DEVICES

(71) Applicant: Sole Power, LLC, Pittsburgh, PA (US)

(72) Inventors: Hahna Ruth Alexander, Pittsburgh, PA (US); Davit Frengul Davitian, Pittsburgh, PA (US); Elliot Isaac Kahn, Pittsburgh, PA (US); Lucas O. Nene, Pittsburgh, PA (US); Matthew James Stanton, Pittsburgh, PA (US)

(21) Appl. No.: 14/305,358

(22) Filed: Jun. 16, 2014

Related U.S. Application Data
(60) Provisional application No. 61/835,170, filed on Jun. 14, 2013.

(51) Int. Cl. H02J 7/00; A43B 3/00

(52) U.S. Cl. CPC H02J 7/0042; H02J 7/0052; H02J 7/0047; A43B 3/0015; H02J 2007/005
USPC 320/107

(57) ABSTRACT

An energy generation and storage system includes an energy generation device within a component of a shoe. The system also includes an energy storage device having an attachment structure configured to removably secure the energy storage device to the shoe or the shoe's wearer and electrically connect to the energy generation device via a power cord.

### RELATED APPLICATIONS AND CLAIM OF PRIORITY

This patent document claims priority to U.S. provisional patent application 61/835,170, filed Jun. 14, 2013. The disclosure of the priority document is fully incorporated into this document by reference.

### BACKGROUND

In remote locations or locations without reliable power systems, it can be difficult to keep batteries for portable electronic devices charged. Individuals who hike, camp or boat may go many hours or days without being near an energy source. Even populated areas may not always have reliable energy sources available, as weather systems, unstable governing bodies and lack of resources can cause power shortages or outages.

United States Patent Application Pub. No. 2014/0145450, filed Apr. 29, 2013 and fully incorporated into this document by reference, describes a wearable energy harvesting mechanism that is installed in a person's shoe and that generates energy as the person steps downward on the mechanism.

The inventors have determined that it is useful to improve devices such as that described above. In addition, energy storage systems that can work with wearable energy harvesting mechanisms are also desirable.

This patent document describes devices that solve problems such as those described above.

### SUMMARY

In an embodiment, an energy generation and storage system includes an energy generation device formed as a component of a shoe. The system also includes an energy storage device that includes an attachment structure configured to removably secure the energy storage device. The storage device may electrically connect to the energy generation device via a power cord. The energy storage device may include a holster and a battery unit having at least one power port. The holster includes a cavity that holds the battery unit. The holster also may include one or more fastening structures comprising a flap that, when installed, is threaded around at least one rung of a shoelace of the shoe and that at least partially covers an opening that receives the battery into the cavity.

Optionally, the holster also may include a receiving channel that, when installed, receives a portion of the shoelace that is proximate an ankle area of the shoe. The holster's flap may include a shoelace-engaging portion and a fastening portion, wherein the shoelace-engaging portion is wider than the fastening portion. If so, the holster also may include a buckle that is sized and positioned to receive the fastening portion.

In some embodiments, the component of the shoe that includes the generation device may include an insole that has a port positioned along a side of the insole in an arch area of the insole. The power cord extends from the port to the storage unit.

The battery unit may include lights configured to selectively illuminate based on a level of charge of the battery unit. In some embodiments, the battery unit also may include a rectifier, a first regulating circuit, a battery indicator circuit, and a second regulating circuit.

Optionally, the battery unit also may include a transmitter connected to an output of the battery indicator circuit, wherein the transmitter is configured to transmit a signal that contains an indicator of a level of charge in the battery unit. If so, the transmitter may interact with a mobile electronic device that is within a communication range of the transmitter. The mobile electronic device may execute or otherwise access an application that causes the device to receive the signal that contains an indicator of a level of charge in the battery unit, and to output a graphic indication of the level of charge on a display of the mobile electronic device. The application also may cause the device to be able to identify a time period (such as a default or user-selected time period), determine a measure of an amount of energy generated by the energy generation device during the time period, and cause the display to output a graphic indication of the amount of energy generated during the time period.

### BRIEF DESCRIPTION OF THE DRAWINGS

FIG. 1 illustrates a shoe having an energy generation device in the insole and an energy storage device attached to the shoe.

FIG. 2 illustrates an alternate structure for securing an energy storage device to a person.

FIG. 3 illustrates an example of a battery unit of an energy storage device being used to charge a portable electronic device.

FIGS. 4 and 5 illustrate an example of a holster that is used to secure a battery unit of an energy storage device to a shoe that is equipped with an energy generation system.

FIGS. 6A and 6B illustrate an alternate embodiment of a holster.

FIG. 7 illustrates an alternate embodiment of an energy storage device that may not require a separate holster.

FIG. 8 illustrates an alternate embodiment using a prosthetic foot.

FIGS. 9 and 10 are circuit diagrams of various example interior components of a battery unit, along with external devices with which the battery unit may interact.

### DETAILED DESCRIPTION

As used in this document, any word in singular form, along with the singular forms “a,” “an” and “the,” include the plural reference unless the context clearly dictates otherwise. Unless defined otherwise, all technical and scientific terms used in this document have the same meanings as commonly understood by one of ordinary skill in the art. All publications mentioned in this document are incorporated by reference. As used in this document, the term “comprising” means “including, but not limited to.” The word “plurality” is intended to mean “more than one.”

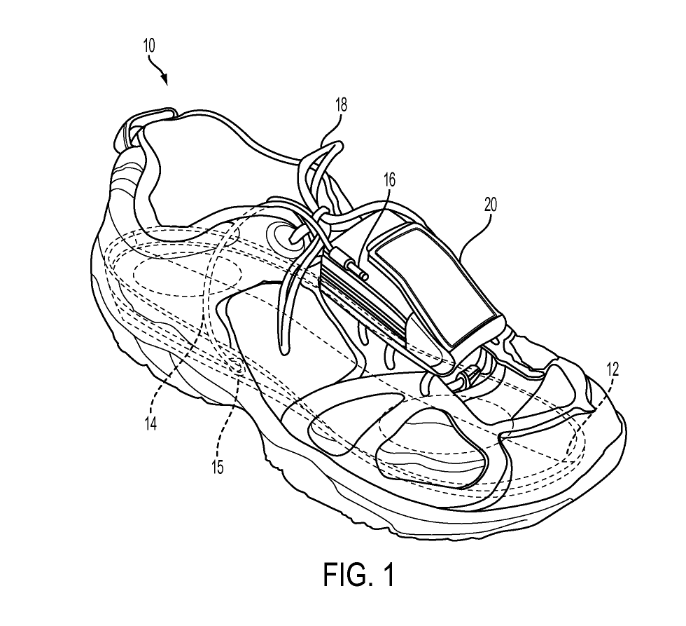

FIG. 1 illustrates an example shoe 10 having an energy generation mechanism embedded within or under the shoe's insole 12. The energy generation mechanism may be one such as that described in United States Patent Application Pub. No. 2014/0145450, filed Apr. 29, 2013, or variations of such a mechanism that generate energy in response to being activated by a human stepping action. The energy generation mechanism may be embedded within the insole as shown, or within another component of the shoe, such as the sole. When this document uses the term “shoe,” it is intended to generally refer to any item of footwear, including but not limited to a shoe, boot, sandal, sock or other footwear item.

A power cord 14 leads from the energy generation mechanism via a port 15 in the insole 12 or other shoe component to an energy storage unit 20. The power cord may be equipped with a plug 16 so that it may be removed from the storage unit 20. In various embodiments, the power cord 14 may include one or more conductors surrounded by an insulating material. The cord is a conductor and may be round, oval shaped, or in some embodiments shaped so that a side of the cord having a widest dimension abuts the wearer's foot while a side having a shorter dimension extends away from the foot. This relatively flat shape may result in more comfort for the user within the shoe. In addition, the port 15 may be positioned on a side of the insole in a location between the heel area and the ball of the wearer's foot, and in some embodiments under the instep and/or in the area of the medial arches of the wearer's foot. In this way, the wire may extend upward from the insole in a location that is in proximate and in front of the ball of the wearer's ankle (i.e., the medial malleolus or the lateral malleolus) so that the wire does not cause discomfort to the wearer. Other locations are possible.

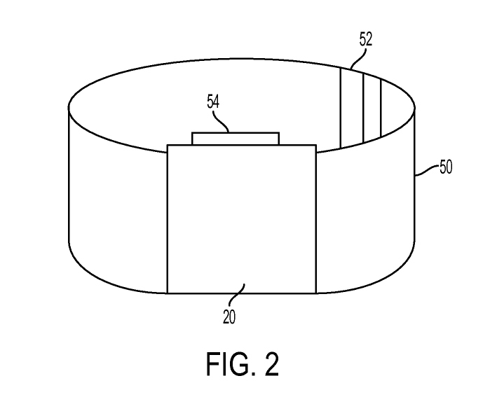

The power storage unit 20 may include features that enable it to be removably attached to a shoelace 18 or other component of the shoe 10 as shown in FIG. 1. An example of this configuration will be described in more detail below. An alternate arrangement is shown in FIG. 2, in which the power storage device 20 is removably attached to a wearable securing band 50. In some embodiments, the band 50 may be made of fabric and may have a fastening component 52 such as overlapping hook-and-loop (e.g., Velcro®) end components, clips, zippers, snaps or other fasteners so that the band can be wrapped around a person's ankle or other extremity. Alternatively, the band may be made of an elastic material so that it can be slipped over the extremity to be worn. The power storage device 20 may be removably attached to the band 50 by a securing clip 54, or by another securing structure such as by hook-and-loop connectors, attachment fins located on the sides of the storage device, or other structures. In addition, the band 50 may include a pocket or other receiver to accept and hold the storage device 20. In addition, the band 50 may include an outer layer made of a durable fabric, leather or synthetic material, along with an inner comfort layer made of a softer and/or moisture-wicking material.

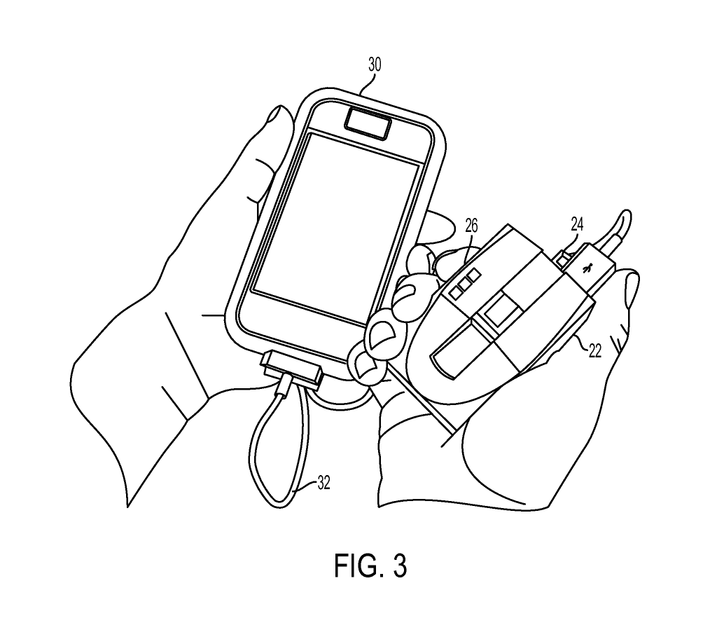

FIG. 3 illustrates an example battery unit 22 of an energy storage device while it is being used to charge a mobile electronic device 30, in this case a mobile phone. The battery unit 22 includes a battery contained within a housing, at least one power port 24 to which a power wire 32 may be attached to transfer energy to the battery from a power source (to charge the storage device) or from the battery to a portable electronic device 30 (to transfer energy from the battery to the electronic device). The device may include multiple power ports to charge multiple devices at the same time, or to both receive a charge from the wearable energy generation system and transfer the charge to a mobile device at the same time. In some embodiments, some or all ports may provide both input and output functions, or certain ports may be input ports while others may be output ports. The ports may be Universal Serial Bus (USB) ports, a plug or socket to receive direct current (DC) power. The battery unit may include other components as well, such as an on-off switch that can be used to control discharging of the device.

The battery unit 22 or another part of the energy storage device may include one or more charge indicators 26 such as light emitting diodes (LEDs) or other lights that depict a level of activity of the device. For example, all of the LEDs may illuminate when the battery is fully charged, while progressively fewer than all of the LEDs may illuminate when the battery is less than fully charged. The LEDs may blink or change color to illustrate various activities such as charging or discharging.

The battery unit 22 may hold one or more rechargeable batteries, such as nickel cadmium (NiCd), nickel metal hydride (NiMH), lithium ion (Li-ion) or lithium ion polymer (Li-ion polymer) batteries, along with electronic circuitry for charging and discharging the batteries.

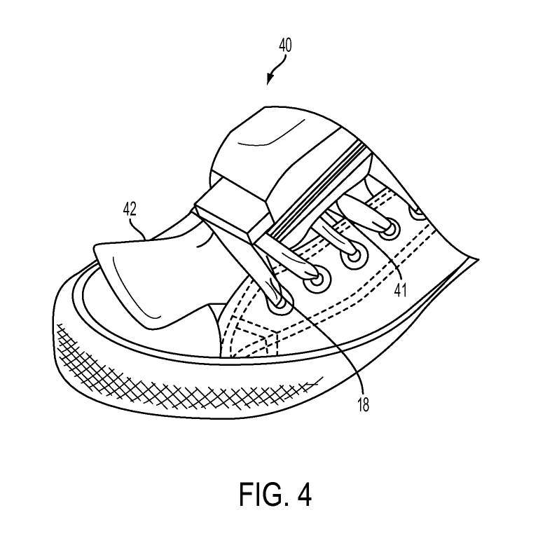

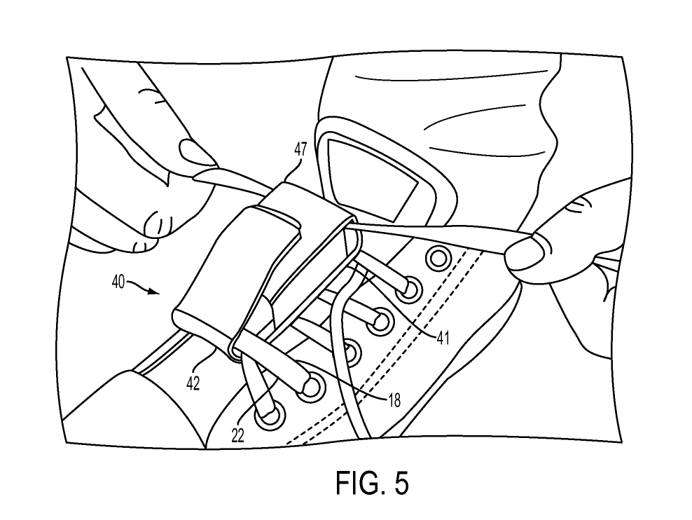

FIGS. 4 through 6 illustrate how an embodiment of the energy storage device 20 of FIG. 1 may be attached to a shoelace 18 of a shoe. When this document uses the term “shoelace,” it is intended to refer to laces, straps or other structures that have multiple rungs and that are positioned over the instep of the wearer's foot between the ankle and the toes. This embodiment includes a holster 40 that defines a cavity 41 to receive the battery unit 22. The holster may be made of fabric, synthetic material, a polymer or other material. The cavity 41 is substantially closed on at least four sides, and a front portion (and optionally a rear portion) includes an opening that may be accessed via a flap 42. A user may insert the battery unit 22 into the cavity 41 via this opening, and thread the flap 42 under one or more rungs of the shoelace 18 that are closest to the toe of the shoe. The user may then pull the flap 42 back over the shoelaces 18 and secure the flap to the holster 40 via a fastening structure such as hook-and-loop components, one or more buckles, snaps, clips or other fasteners, or any combination of these, as shown in the example of FIG. 5. FIG. 5 also illustrates that the holster 40 may include one or more rear channels 47 to be located near the ankle area through which a user may thread one or more upper rungs of the shoelace 18, thus securing the holster 40 to the shoe via the shoelace 18. The channels may be, for example, one or more loops or rings of fabric, polymer or synthetic material secured to a rear area of the holster.

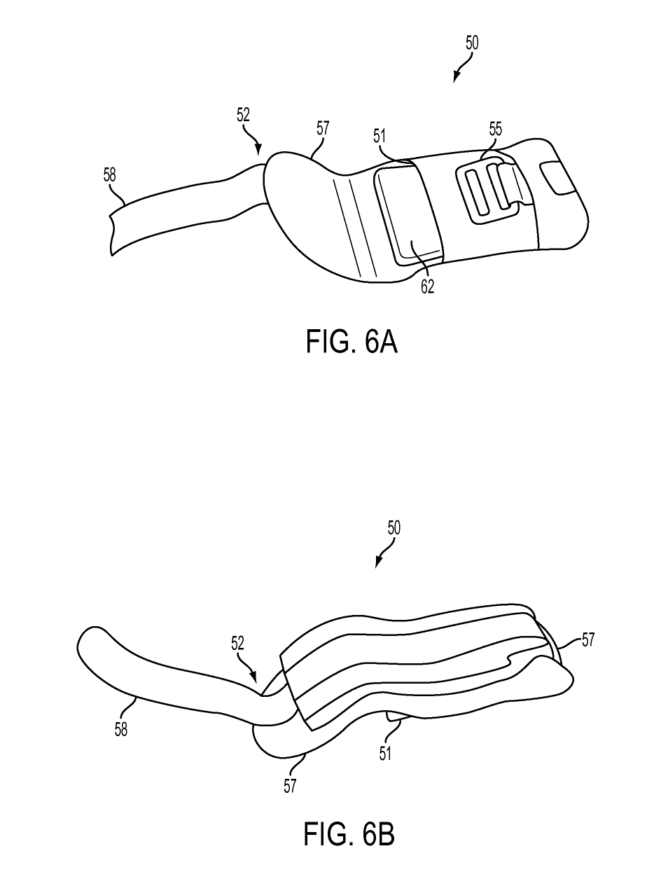

FIGS. 6A and 6B illustrate a top perspective view and a bottom perspective view, respectively, of an alternate holster 50 in which the flap 52 includes a first shoelace-engaging component 57 and a second fastening component 58. As with other embodiments, the battery 62 fits inside of a cavity 51 formed by the holster. The shoelace-engaging component 57 of the flap is wider than the fastening component 58 so that the shoelace-engaging component has an increased width to wrap around a rung of the shoelace. The fastening component 58 may be narrower and sized to fit within a buckle 55 positioned on the outside of the holster. After it is threaded through the buckle 55, the fastening component may be pulled back and attached to itself or to another component of the holster via hook-and-loop fasteners, snaps, a slot, or another connecting component. In this embodiment, the flap 52 wraps all the way to the rear of the holster and thus also forms the channel 57 that receives an upper rung of the shoelace.

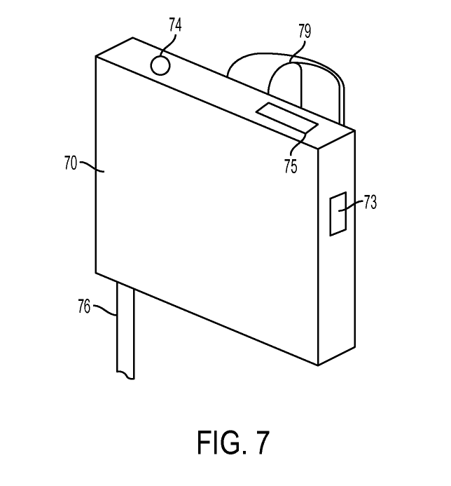

FIG. 7 illustrates an alternate embodiment of a battery unit 70 of an energy storage device that includes a protective case with a battery contained inside the case. This embodiment may or may not be used with a holster. The unit may include one or more charge indicators 74 such as lights that selectively brighten or dim to indicate the level of charge of the battery, and one or more input/output ports 75, 76 for transferring charge to and from the battery. The device also may include a clip or other connector 78 that may be used to fasten the battery unit to a shoe. In this embodiment, the clip 78 may slip underneath multiple rungs of a shoelace to be held in place. Optionally, the battery unit also may have a switch 73 that enables the device to be turned on and off, so that the device only discharges when the switch 73 activates the battery unit to an “on” mode.

In some embodiments, the battery unit, the holster or both may be made of a water-proof or water-resistant material. In addition, the battery unit's power ports may be made of waterproof and/or dustproof components, such as waterproof USB ports that are now known or which become known in the future. The battery unit, the holster or both also may include an opening or transparent window in a location that corresponds to the LEDs, so that the LEDs are visible to the wearer.

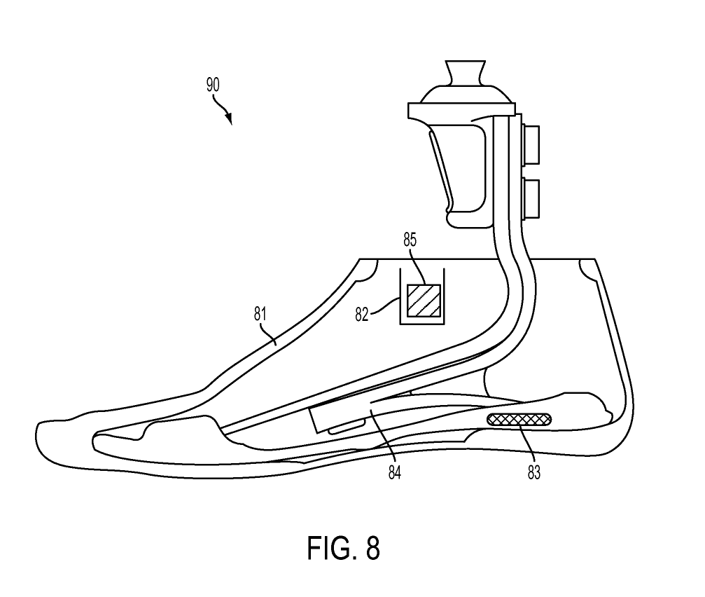

FIG. 8 illustrates an alternate embodiment in which the “shoe” is a prosthetic foot 80. The foot includes or is used with a housing 81 that is generally shaped as a shoe, or as a foot to fit within the shoe. The base of the housing 81 includes an insole area in which the energy generating device 83 is installed. The housing may be installed within the foot as shown, the housing may be integral with the foot, or a two-part housing may include a detachable component that may be removed from the foot, such as a detachable sole that contains the energy generating device 83. When a person wears the prosthetic foot and exerts downward pressure on the foot and housing, the energy generating device 83 generates energy. The housing also includes a holster 82 that removably receives an energy storage device 85. The energy generating device 83 and energy storing device 85 may be connected via a power cable when the energy storage device 85 is seated within the holster 82. Optionally, in embodiments where the prosthetic foot includes one or more flexible springs 84 the energy generating device 83 may be positioned along the base of a the spring at a pressure point where the spring will exert downward pressure toward the bottom of the housing 81 when a person walks on the prosthetic foot.

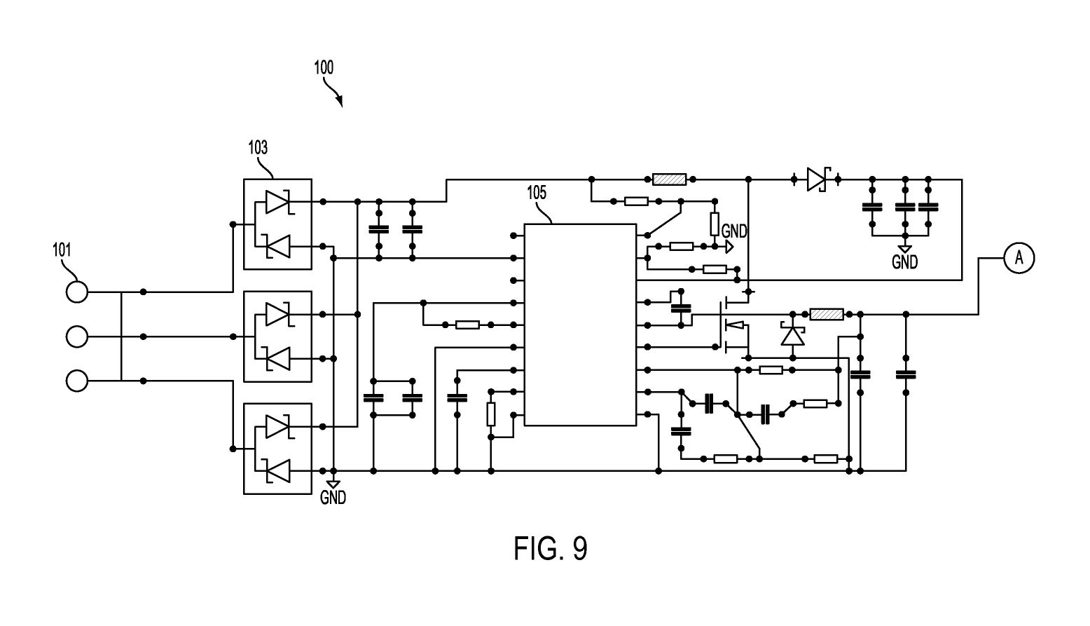

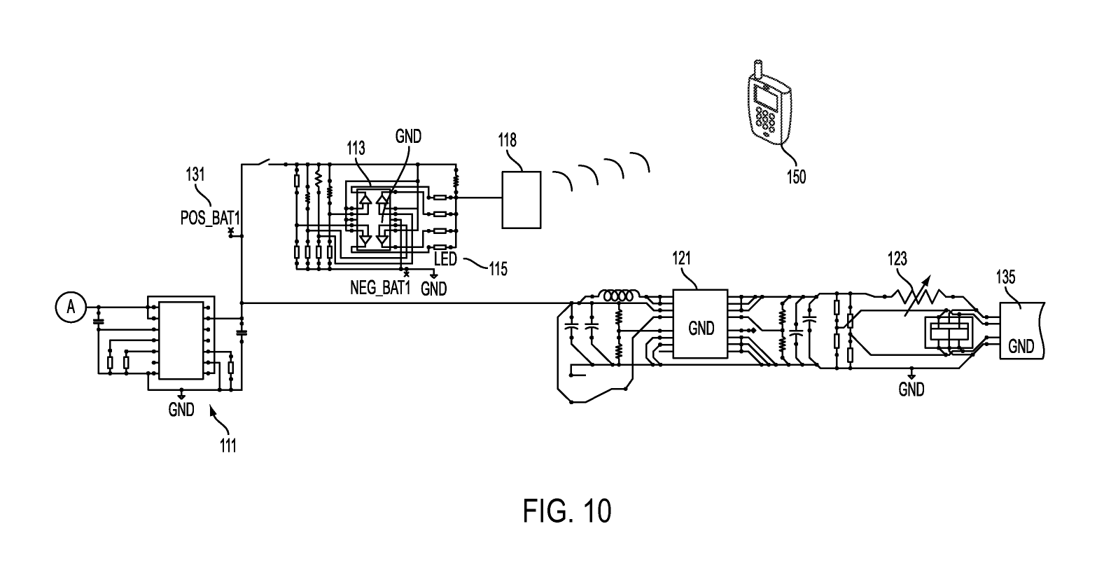

FIGS. 9 and 10 are circuit diagrams of various example interior components of a charging circuit 100 that may be included in a battery unit. The circuit receives power via a set of contacts 101 that are connected to the energy generating device via the power cable. A full bridge rectifier 103 converts the input alternating current (AC) to direct current (DC).

The voltage of the rectifier 103 output may not be sufficient to charge the energy storage unit, and it may be susceptible to power spikes during operation. To address this, a first regulating circuit 105 receives the rectifier output and regulates its voltage to a level corresponding to that of the energy storage device's rated input voltage. The regulating circuit 105 may increase the voltage from the rectifier when necessary, reduces voltage during spikes, or both. In some embodiments, the first regulating circuit may be a buck-boost converter. For example, when used with certain lithium polymer (LiPo) batteries, a buck-boost converter 105 may yield a regulated output voltage in a range of approximately 3.7 volts to approximately 4.2 volts. Other voltage ratings and ranges are possible, typically depending on the rating of the battery that is used with the system.

During a charging operation, the output of the first regulating circuit leads to a charging circuit 111 that may be programmed to regulate the delivery of current to the battery 131. When the charging circuit 111, which as shown is an integrated circuit such as those known now or in the future to persons of skill in the art, detects that the battery unit voltage is less than a threshold level, it may reduce the charging current delivered to the battery 131, and it may increase the current when the voltage rises to at least the threshold. These thresholds may be set by one or more external resistors. When the charging circuit 111 detects that the battery 131 is fully charged or within a threshold amount of being fully charged, the it charging circuit 111 may switch to an end of charge condition and reduce or stop delivering charge to the battery unit. The charging circuit 111 also may include outputs for interfacing with LEDs or other indicators that provide a visual indicator when the device is charging a battery.

A battery indicator 113 is connected between a positive terminal of the battery 131 and ground, and is a circuit that is configured to detect a level of charge in the battery. The battery indicator may include a set of LEDs or other indicators 115 that selectively illuminate to illustrate a level of charge in the battery. The higher the charge in the battery 131, the higher the number of LEDs 115 that will illuminate.

In some embodiments, an output of the battery indicator 113 may be connected to a transmitter 118 that transmits a signal that includes data, or which has a magnitude or frequency, corresponding to a level of charge in the battery. The transmitter 118 may be configured to transmit signals using a short-range communication protocol so that its signals can be detected by a nearby mobile electronic device 150. Examples of such protocols include Bluetooth, Bluetooth Low Energy, RFID, ANT, ANT+, and other near-field communication protocols. The transmitter 118 also may be paired with a microprocessor that converts the signals output by the battery indicator into data that the transmitter will transmit, or which includes programming that performs other function.

The mobile electronic device 150 may include a processor and a computer-readable storage medium with programming instructions that, when executed, cause the processor to run an application that receives the signals from the transmitter 118, use the signals to measure a level of charge in the battery, and output an indicator of a level of charge on a display of the mobile electronic device. The level indicator may include a fuel gauge, a numeric indicator, or another graphic indicator of a level of charge in the battery. Optionally, the color, size or other visual characteristics of the graphic indicator may change when the level of charge exceeds a threshold (such as at least 99% charged) or goes below a threshold (such as less than 50% charge remaining in the battery). The application also may store the received data over time and calculate a function of changes in energy level over a time period, with the result being a measure of the amount of charge generated by the energy generating device over time. The application also cause this measure to be displayed on a display of the output of the mobile electronic device so that when a person using such a mobile electronic device also uses the energy generating device, the application can provide the user a visual indicator showing how much charge that the user has generated over a period of time. The application also provide a user interface via which the user may select, and the application may receive, various time periods, or various time range magnitudes, so that the user can command the application to calculate and display a measure of the amount of power generated over the various time periods or ranges.

During a discharging operation, power from the battery 131 may pass through a second regulating circuit 121 that regulates the voltage of the level that is required for a load 135, such as a mobile electronic device or device battery that is being charged. In some embodiments, the second regulating circuit 121 may include a boost circuit that regulates a charge to remain above a threshold level, a buck circuit that regulates a charge to remain below a threshold level, or a buck/boost converter that regulates a charge to remain within an upper and a lower threshold. The load 135 may be connected to the battery unit via an electrical connector such as a Universal Serial Bus (USB), mini-USB, micro-USB, Lightning or other connector. The circuit also may include a shock overcurrent and electrostatic discharge protection circuit 123, such as a variable resistor in combination with a filter as shown, to provide an additional level of protection during extreme electrical events.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. An energy generation and storage system, comprising:
an energy generation device within a component of a shoe; and
an energy storage device comprising an attachment structure configured to removably secure the energy storage device and electrically connect to the energy generation device via a power cord.

2. The system of claim 1, wherein the energy storage device comprises:
a battery unit having at least one power port; and
a holster comprising a cavity that holds the battery unit and a plurality of fastening structures configured to secure the holster to a shoelace of the shoe.

3. The system of claim 2, wherein a first one of the fastening structures comprises a flap that, when installed, is threaded around at least one rung of the shoelace and at least partially covers an opening that receives the battery into the cavity.

4. The system of claim 3, wherein a second one of the fastening structures comprises a receiving channel that, when installed, receives a portion of the shoelace that is proximate an ankle area of the shoe.

5. The system of claim 1, wherein:
the component of the shoe comprises an insole that includes a port positioned along a side of the insole in an arch area of the insole; and
the power cord extends from the port.

6. The system of claim 2, wherein the battery unit comprises a plurality of lights configured to selectively illuminate based on a level of charge of the battery unit.

7. The system of claim 3, wherein the flap comprises a shoelace-engaging portion and a fastening portion, wherein the shoelace-engaging portion is wider than the fastening portion.

8. The system of claim 3, wherein the holster further comprises a buckle sized and positioned to receive the fastening portion.

9. The system of claim 2, wherein the battery unit comprises:
a rectifier;
a first regulating circuit;
a battery indicator circuit; and
a second regulating circuit.

10. The system of claim 2, wherein the battery unit also comprises a transmitter connected to an output of the battery indicator circuit, wherein the transmitter is configured to transmit a signal that contains an indicator of a level of charge in the battery unit.

11. The system of claim 10, further comprising programming instructions that, when executed, cause a mobile electronic device that is within a communication range of the transmitter to:
receive the signal that contains an indicator of a level of charge in the battery unit; and
output, on a display of the mobile electronic device, a graphic indication of the level of charge.

12. The system of claim 11, further comprising additional programming instructions that, when executed, cause the mobile electronic device to:
identify a time period;
determine a measure of an amount of energy generated by the energy generation device during the time period; and
output, on the display, a graphic indication of the amount of energy generated during the time period.

13. The system of claim 1, wherein the shoe comprises a prosthetic foot.

14. An energy generation and storage system, comprising:
an energy generation device formed as a component of a shoe; and
an energy storage device comprising an attachment structure configured to removably secure the energy storage device and electrically connect to the energy generation device via a power cord, wherein the energy storage device comprises:
a battery unit having at least one power port, and
a holster comprising a cavity that holds the battery unit and a first fastening structure comprising a flap that, when installed, is threaded around at least one rung of a shoelace of the shoe and at least partially covers an opening that receives the battery into the cavity.

15. The system of claim 14, wherein the holster also comprises a receiving channel that, when installed, receives a portion of the shoelace that is proximate an ankle area of the shoe.

16. The system of claim 14, wherein:
the component of the shoe comprises an insole that includes a port positioned along a side of the insole in an arch area of the insole; and
the power cord extends from the port.

17. The system of claim 14, wherein the battery unit comprises a plurality of lights configured to selectively illuminate based on a level of charge of the battery unit.

18. The system of claim 14, wherein the flap comprises a shoelace-engaging portion and a fastening portion, wherein the shoelace-engaging portion is wider than the fastening portion.

19. The system of claim 18, wherein the holster further comprises a buckle sized and positioned to receive the fastening portion.

20. The system of claim 14, wherein the battery unit comprises:
a rectifier;
a first regulating circuit;
a battery indicator circuit; and
a second regulating circuit.

21. The system of claim 14, wherein the battery unit also comprises a transmitter connected to an output of the battery indicator circuit, wherein the transmitter is configured to transmit a signal that contains an indicator of a level of charge in the battery unit.

22. The system of claim 21, further comprising programming instructions that, when executed, cause a mobile electronic device that is within a communication range of the transmitter to:
receive the signal that contains an indicator of a level of charge in the battery unit; and
output, on a display of the mobile electronic device, a graphic indication of the level of charge.

23. The system of claim 21, further comprising additional programming instructions that, when executed, cause the mobile electronic device to:
identify a time period;
determine a measure of an amount of energy generated by the energy generation device during the time period; and
output, on the display, a graphic indication of the amount of energy generated during the time period.
